(19) United States
(12) Patent Application Publication
(10) Pub. No.: US 2014/0131288 A1
(43) Pub. Date: May 15, 2014

(54) SUPERPARAMAGNETIC PHOTOCATALYTIC MICROPARTICLES

(71) Applicants: Frank Gu, Waterloo (CA); Timothy Michael Carter Leshuk, Waterloo (CA); Stuart Linley, Waterloo (CA)

(72) Inventors: Frank Gu, Waterloo (CA); Timothy Michael Carter Leshuk, Waterloo (CA); Stuart Linley, Waterloo (CA)

(21) Appl. No.: 14/118,255

(22) PCT Filed: May 17, 2012
(86) PCT No.: PCT/CA2012/050323

§ 371 Date: Jan. 14, 2014

Related U.S. Application Data
(60) Provisional application No. 61/457,710, filed on May 17, 2011.

(51) Int. Cl. C02F 1/72; B01J 23/745; B01J 37/02; C02F 1/32

(52) U.S. Cl. CPC C02F 1/725; C02F 1/32; B01J 23/745; B01J 37/0221
USPC 210/748.14; 252/62.59; 427/127

(57) ABSTRACT

This disclosure is directed at a microparticle for use in water treatment comprising a core layer; a shell layer, deposited on and encasing the core layer; and a photoactive layer surrounding the shell layer. The disclosure also provides a method for producing same.

### CROSS-REFERENCE TO RELATED APPLICATIONS

This application claims priority from U.S. Provisional Application No. 61/457,710 filed May 17, 2011, which is incorporated herein by reference.

### FIELD OF THE DISCLOSURE

The disclosure is generally directed at water treatment and more specifically at a method and apparatus for producing superparamagnetic photocatalytic microparticles.

### BACKGROUND OF THE DISCLOSURE

Water treatment is a critical function for public and environmental health, yet despite great progress and technological innovation in this field over the past century, many challenges remain. As the toxicological and environmental effects of various waterborne contaminants become elucidated in the progress of science, the necessity of new approaches and technologies to address these concerns becomes apparent. For example, the persistence of various organic chemical pollutants such as polychlorinated biphenyls, pharmaceuticals, endocrine inhibitors, pesticides, solvents, and other toxins is an ongoing concern in water treatment. Furthermore, pathogens such as Cryptosporidium parvum and Mycobacterium avium are recalcitrant to chlorine-based water disinfection technology, forcing reliance on expensive alternative treatment technologies such as ultraviolet (UV) light or ozone based disinfection.

Nanoscale titanium dioxide (TiO₂) has been researched over the past decades for use in water treatment due to its low cost and high efficiency as a photocatalyst. In illuminated aqueous solutions, nanoscale TiO₂ functions by absorbing incident light to generate reactive oxygen species and free radicals, which participate in the oxidative destruction and mineralization of many organic chemicals and other contaminants in water, including viral and microbial pathogens. While TiO₂ can offer these advantages in versitility, traditional challenges limiting economical deployment of this material in realistic water treatment applications include the problem of recovering and recycling TiO₂ nanoparticles, as well as the insufficient activity of TiO₂ when used with solar illumination. Recent developments in semiconductor and surface engineering promise to allow TiO₂ to be used effectively with sunlight, yet a solution for the cost-effective recovery and recycling of the catalyst has remained elusive.

TiO₂ nanoparticles are an efficient form of the material for water treatment, due to the high surface area that nanofabrication affords. TiO₂ nanoparticles are also most effective when mixed with the contaminated water as a colloidal dispersion of nanoparticles throughout the contaminated water volume, known as a “slurry” type system, as this allows optimal mass transfer and mixing with chemical contaminants, as well as radiant flux to reach the nanoparticle surface. After the water has been photocatalytically treated, the TiO₂ nanoparticles need to be recovered so that they themselves do not serve as a contaminant within the water and also to recover the catalyst for reuse. However, the challenge of separating nanoparticles from an aqueous dispersion has critically limited the application of nanoscale TiO₂ in the past. One approach that has been investigated is to flocculate the nanoparticles, or adjust the solution pH to the isoelectric point of TiO₂ using chemical additives, which induces the TiO₂ nanoparticles to aggregate into larger agglomerates. These agglomerates can then be settled by gravity over a period of time. This approach is undesirable due to the low water throughput in terms of having to wait for the TiO₂ nanoparticles to gravimetrically settle out of suspension, as well as possible addition of chemical additives, which adds to the process cost and reduces potability of the processed water. An alternative is to directly filter the TiO₂ nanoparticles from the water using membrane technology. However, the use of fine filters to exclude, or filter out, very fine nanoparticles can be expensive, and membrane fouling over time would force replacement, again adding significant costs to the water treatment process as a whole.

In light of these challenges, various researchers have abandoned the idea of a slurry-based system for TiO₂ nanoparticle deployment, and have focused instead on immobilizing TiO₂ nanoparticles on various fixed substrates, such as membranes through which contaminated water would flow. While these options address the challenges of nanoparticle extraction from suspension, the photocatalytic efficiency of the entire treatment process is significantly diminished by immobilization. The efficient mixing and mass transfer of the slurry system is lost in immobilized nanoparticles, and challenges of ensuring radiant photons can illuminate the nanoparticle-coated surfaces arise. Fundamentally, the TiO₂ surface area is also often diminished through immobilization, again impeding the efficiency of the material in removing contaminants from solution.

Magnetic separation technology is therefore an attractive proposition in order to achieve sufficiently fast nanoparticle separation from a slurry-type photocatalytic treatment system, as TiO₂ nanoparticles can be attached to magnetic particulate supports and hence become susceptible to an externally applied magnetic field. However, it is insufficient to attach TiO₂ to any magnetic material or particle, due to the nature of the physics involved in a slurry-type colloidal photocatalytic system. For example, single-crystal magnetite particles larger than about 30 nm in diameter are ferromagnetic, and as such possess a permanent magnetic dipole at room-temperature once magnetized. This is problematic in a slurry-type system, as the multiple particles in the dispersion will experience magnetic attractions to each other, promoting the formation of large flocs, or flakes, which can rapidly settle out of the dispersion, impeding the photocatalysis of any attached TiO₂ nanoparticles. Magnetite nanocrystals smaller than about 30 nm in diameter possess the property of superparamagnetism, in that they possess no remnant magnetization at room temperature in spite of being previously exposed to a magnetic field. However, when superparamagnetic nanocrystals are exposed to an externally applied magnetic field, they regain magnetic dipoles, and transiently form larger aggregates and flocs which are quickly removed from solution in the direction of the magnetic field gradient. Thus, superparamagnetism is an essential property for colloidal slurry-type photocatalysis, as after the separating magnetic field is removed, the particle aggregates can easily dissociate and reform a fine dispersion which is stable against gravitational settling.

Unfortunately, superparamagnetic nanocrystals typically possess too small a magnetic force per particle even when fully magnetized to be easily magnetically separated from solution when they are loaded with other non-magnetic materials such as TiO₂, as the non-magnetic material lowers the net saturation magnetization of the composite particles, and can also inhibit the formation of the transient magnetic particle aggregates essential for separation. These issues can significantly slow down the magnetic separation process to the point where it is no longer economically advantageous, as well as allow for the possibility of some nanocrystals which do not associate with transient magnetic aggregates remaining in solution as contaminants themselves.

Therefore, there is provided a method and apparatus for producing superparamagnetic photocatalytic microparticles for use in water treatment which overcomes disadvantages in the prior art.

### SUMMARY OF THE DISCLOSURE

The current disclosure is directed at a method and apparatus for producing superparamagnetic photocatalytic microparticles. In one embodiment, to overcome issues with magnetic separation, it was realized that there is a need to pre-form aggregates of superparamagnetic nanoparticles or nanocrystals prior to loading or depositing a material such as TiO₂ onto the surface, as by this process each composite particle may possess significantly increased magnetic moment during magnetic separation due to the multiple nanoparticles or nanocrystals at their core, yet would also retain the property of superparamagnetism to minimize magnetic aggregation of the particles during the photocatalytic water treatment processes, allowing for the formation of a fine slurry which is stable against gravitational settling.

In one embodiment, the disclosure described herein involves the surface immobilization of TiO₂ onto colloidal superparamagnetic substrate microspheres to produce a water treatment material, while incorporating TiO₂ doping and surface treatment to allow the water treatment material to be used efficiently under solar, visible light, or infrared illumination or any combination of the three. In use, the water treatment material allows for efficient mixing of the TiO₂ with contaminated water which may then be followed by cheap, fast and simple magnetic recycling of the catalyst or microparticles. In this manner, these particles could be used continually for water decontamination, with sunlight as the only necessary input. In a preferred embodiment, this disclosure is useful for water treatment applications, either on a societal or industrial scale, or in point-of-use or portable systems. Although described with respect to water treatment, the material may also be used for treatment in other domains, such as, but not limited to, the filtration of contaminated air. This disclosure may also be useful in other antimicrobial or disinfectant applications, personal care products, chemical reactions, lithium ion storage, drug delivery, cancer treatment, magnetic resonance imaging, or water splitting for hydrogen generation.

### BRIEF DESCRIPTION OF THE DRAWINGS

Embodiments of the present disclosure will now be described, by way of example only, with reference to the attached Figures, wherein:

FIG. 1a is a schematic diagram of a microparticle;

FIG. 1b is a three-dimensional schematic diagram of the microparticle of FIG. 1;

FIG. 2 is a flowchart outlining a method of forming a microparticle;

FIG. 3 is a transmission electron micrograph of superparamagnetic core particles, prepared according to example 1;

FIG. 4 is a transmission electron micrograph of superparamagnetic core particles coated with an electrically insulating layer of silicon dioxide prepared according to example 1;

FIG. 5 is a transmission electron micrograph of composite microparticles comprising superparamagnetic core particles, coated with an electrically insulating layer of silicon dioxide, coated with a surface layer of titanium dioxide, prepared according to example 1.

FIG. 6 is a transmission electron micrograph of the superparamagnetic core particles, composed of multiple smaller superparamagnetic nanocrystals, prepared according to example 2;

FIG. 7 is a high magnification transmission electron micrograph of the superparamagnetic core particles, composed of multiple smaller superparamagnetic nanocrystals, prepared according to example 2;

FIG. 8 is a transmission electron micrograph of superparamagnetic core particles coated with an electrically insulating layer of silicon dioxide, prepared according to example 2;

FIG. 9 is a transmission electron micrograph of composite microparticles comprising of superparamagnetic core particles, coated with an electrically insulating layer of silicon dioxide, coated with a surface layer of amorphous titanium dioxide, prepared according to example 2;

FIG. 10 is a transmission electron micrograph of the composite microparticles consisting of superparamagnetic core particles, coated with an electrically insulating layer of silicon dioxide, coated with a surface layer of titanium dioxide, prepared according to example 2;

FIG. 11 is a high magnification transmission electron micrograph of the composite microparticles comprising of superparamagnetic core particles, coated with an electrically insulating layer of silicon dioxide, coated with a surface layer of titanium dioxide, and subsequently hydrothermally treated, according to example 2;

FIG. 12 is a chart outlining results from a photocatalytic degradation of methylene blue experiment using the microparticles of example 1;

FIG. 13 is a chart outlining results from a photocatalytic degradation of methylene blue experiment using the presented microparticles of example 3;

FIG. 14 is a chart outlining results from a photocatalytic degradation of methylene blue experiment using the presented composite microparticles modified with Pd according to example 4 (▴) compared to the composite microparticles of example 2 which do not contain Pd () with a standard degradation curve of a 5.5 mg/L methylene blue solution in the absense of catalysts under the same irradiation conditions is also presented as a control (▪);

FIG. 15 is a chart outlining results from a photocatalytic degradation of methylene blue experiment using the presented composite microparticles modified with Ag according to example 5 (▴), compared to the composite microparticles of example 2 which do not contain Ag ();

FIG. 16 is a recyclability study showing the ability of the particles to be used consecutive times without a significant decrease in photocatalytic activity;

FIG. 17 is an example of the stability of the colloidal suspension or slurry of the composite microparticles against gravitational settling;

FIG. 18 is an example of magnetic separation of composite microparticles from a colloidal suspension or slurry;

FIG. 19 is a schematic view of a system for water treatment;

FIG. 20a is a cut away side view of a second system for water treatment; and

FIG. 20b is a front view of the second system.

### DETAILED DESCRIPTION OF THE DISCLOSURE

The present disclosure is directed at a method and apparatus for producing superparamatnetic, photocatalytic core-shell composite microparticles which may be used in water treatment processes. Each microparticle includes a core layer, a shell layer and a photoactive layer. In one embodiment, the photoactive layer may be a combination of a charge carrier generation layer and a light responsive layer or may be a single layer capable of charge carrier generation and being responsive to light. In the embodiment where the photoactive layer is a single layer, the photoactive layer may be modified to allow it to act as a photocatalyst when exposed to solar, visible or infrared light, in addition to or instead of the material's native ultraviolet light photocatalytic activity. The core layer of the composite microparticles contains multiple superparamagnetic nanocrystals, or nanoparticles.

The present disclosure is also directed at a synthesis of superparamagnetic, photocatalytic core-shell composite microparticles. Herein the term “microparticles” is held to mean particles with a mean diameter between approximately 0.01 μm and approximately 100 μm.

An advantage of the current disclosure is that microparticles are recyclable and may be reused for multiple water treatment processes. Also, since the microparticles are activated by light, there are lower operational costs as it is a scalable and relatively inexpensive particle synthesis process. Another advantage is that no chemical additives need to be added to the water for the water treatment process. The microparticles also provide a versatile treatment option for most organic contaminants.

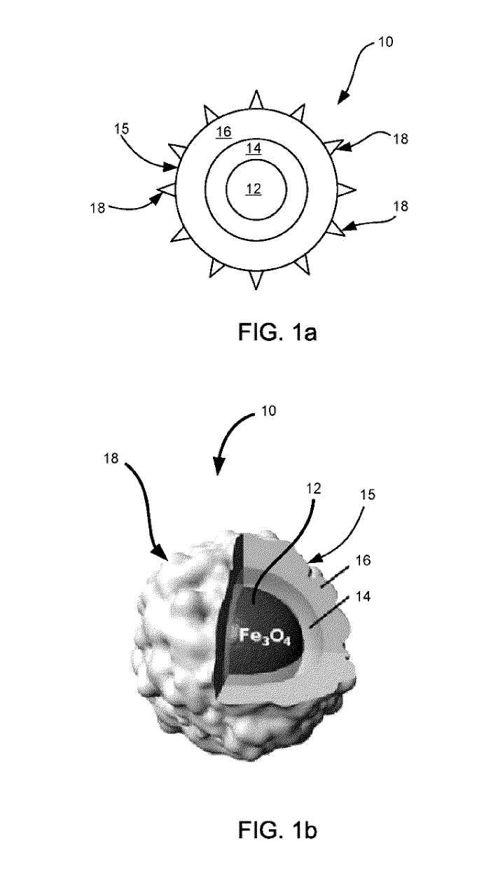

Turning to FIG. 1a, a schematic diagram of a superparamagnetic photocatalytic microparticle is shown. FIG. 1b provides a partially cut-away three-dimensional view of the microparticle of FIG. 1a. The microparticle forms part of the water treatment material and may be formed in a number of different ways, as will be described below.

The microparticle 10 includes at least three layers which may be seen as a recyclable core layer 12, an inner sealant or shell layer 14 and a photoactive layer 15. The photoactive layer 15 may include a charge carrier generation layer, or portion, 16 and a solar or visible light responsive layer, or portion 18. The generation layer 16 and the light responsive layer 18 may be seen as two separate layers or they may be integrated together as one layer or a single layer made from the same material. As can be seen in FIGS. 1a and 1b, the light responsive layer 18 may be a collection of protrusions extending from the charge carrier generation layer 16, may be integrated with the charge carrier generation layer 16 or may be created from the charge carrier generation layer by processing of the generation layer 16. Although described as separate layers, the creation of the light responsive layer may be achieved by modifying the surface of the charge carrier generation layer, such as by doping the charge carrier generation layer. In this embodiment, the “layers” 16 and 18 may be seen as the single photoactive layer 15.

In one embodiment, as schematically shown in FIG. 1b, the recyclable core layer 12 is made of iron oxide (Fe₃O₄), the shell layer 14 is made of silicon dioxide (SiO₂) while the generation layer 16 and light responsive layer 18 is made of titanium dioxide (TiO₂). By combining a plurality of these microparticles together or by having a plurality of them in the contaminated water, water treatment material may be produced or provided.

In one embodiment, when TiO₂ is used for the generation 16 and light sensitive 18 layers, it is preferred that the TiO₂ is photocatalytically active when exposed to various types of light including ultraviolet light to improve its effectiveness when used for water treatment. In another embodiment, the TiO₂ may be modified to allow it to be photocatalytically active when exposed to at least one of visible, ultraviolet light or infrared light.

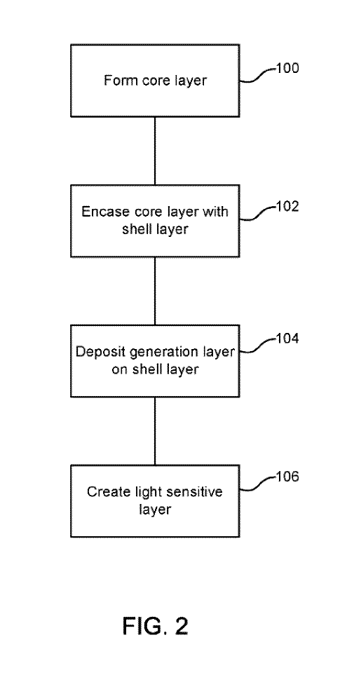

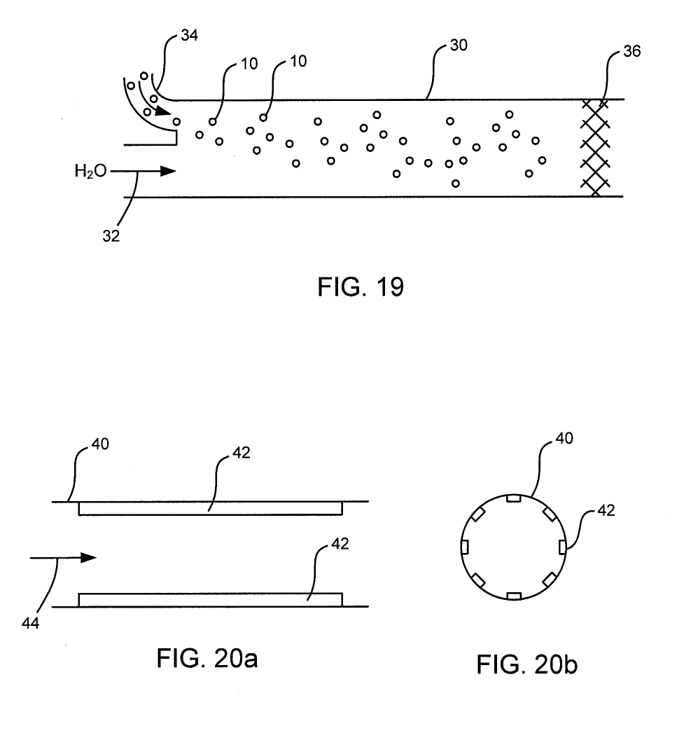

Turning to FIG. 2, a flowchart outlining a method of producing a microparticle is shown. After the microparticles are formed, they may be combined to form the water treatment material for use in the example systems of FIGS. 19, 20a and 20b. Initially, a core layer is formed 100, such as via the synthesis of superparamagnetic particle cores. The property of superparamagnetism prohibits or reduces the likelihood of magnetic dipolar attractions forming between the composite microparticles (when combined to form the water treatment material) at room temperature in the absence of an externally applied magnetic field. This assists to enhance the colloidal stability of dispersions of the microparticles. However, when it is desirable to magnetize the microparticles, a magnetic field may be applied externally, allowing for transient magnetic interactions between the multiple superparamagnetic particles in solution (such as the contaminated water), and enabling magnetophoretic separation of the particles from a suspension. In a preferred embodiment, the superparamagnetic cores contain multiple superparamagnetic nanocrystals per core particle or layer where the nanocrystals may be chemically bound to each other. This allows for the final composite microparticles to possess sufficient magnetic material to obtain a sufficiently strong magnetic moment to enable timely and reproducible magnetophoretic separations.

In performing the synthesis of the cores, different techniques may be employed. For instance, in one embodiment of the present disclosure, the superparamagnetic cores may be synthesized via the oxidative aging of ferrous salts in an alkaline aqueous solution at approximately 90° C. In this process, provided that the oxidation reaction is sufficiently slow, as can be conveniently controlled by the relative concentrations and ratios between reagents, and by using a mild oxidizing agent such as potassium nitrate, magnetite nanocrystals which precipitate during the reaction spontaneously self-assemble into hierarchical spherical aggregate structures on the order of hundreds of nanometers in diameter, due to the minimization of the surface energy of the nanocrystals at their isoelectric point. In other words, the synthesis of the core layer is performed through the oxidative aging of ferrous salts involving an iron salt, a precipitating agent and an oxidizing agent. The precipitating agent may be chosen from a group consisting of hydroxides, carbonates, bicarbonates, phosphates, hydrogen phosphate, ammonia, group 1 salts of carbanions, amides, hydrides, and dihydrogen phosphates of group 1, 2, and ammonium while the oxidizing agent may be chosen from the group comprising nitrates, nitric acid, nitrous oxide, peroxides, oxygen, ozone, permanganates, manganates, chromates, dichromates, chromium trioxide, osmium tetroxide, persulfuric acid, sulfoxides, sulfuric acid, fluorine, chlorine, bromine, iodine, hypochlorite, chlorites, chlorates, perchlorates and other analogous halogen compounds. The iron salt may be chosen from the group consisting of iron (II) chloride, iron (III) chloride, iron (II) sulfate, iron (III) sulfate, iron (II) nitrate, iron (III) nitrate, iron (II) fluoride, iron (III) fluoride, iron (II) bromide, iron (III) bromide, iron (II) iodide, iron (III) iodide, iron (II) sulfide, iron (III) sulfide, iron (II) selenide, iron (III) selenide, iron (II) telluride, iron (III) telluride, iron (II) acetate, iron (III) acetate, iron (II) oxolate, iron (III) oxolate, iron (II) citrate, iron (III) citrate, iron (II) phosphate and iron (III) phosphate.

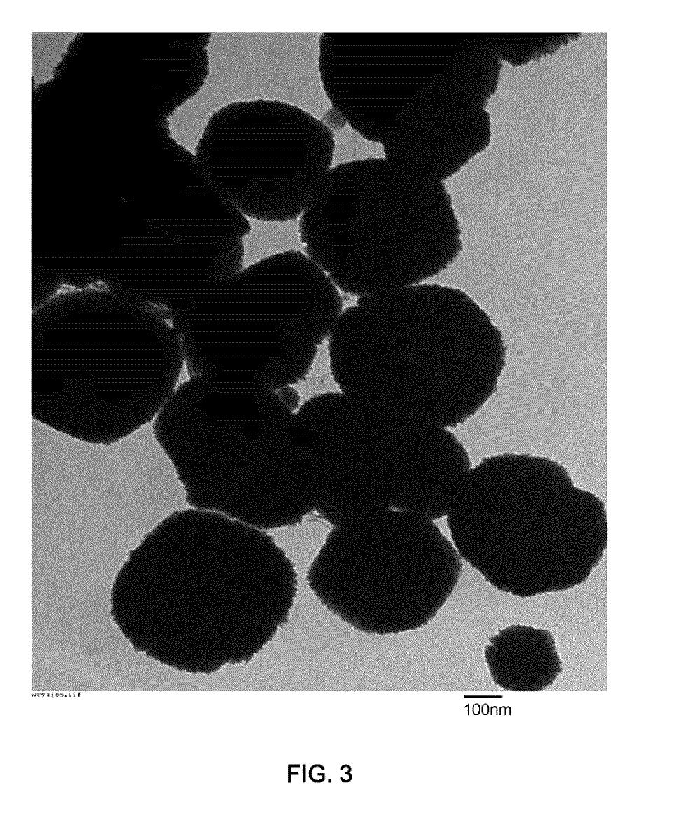

Ferric ions, or other transition metals such as cobalt, nickel or manganese may also be incorporated into the reaction or synthesis to control the kinetics of particle nucleation and self-assembly or to allow the formation of other ferrite materials. A photograph, produced by a transmission electron micrograph, of the core layer, or the core particles (composed of multiple smaller nanocrystals), is shown in FIG. 3.

In other embodiments of the present disclosure, the superparamagnetic particle cores may be formed through a hydrothermal reduction and precipitation of ferric salts in aqueous solution, in the presence of a carboxylate source (such as citrate), a precipitant (such as urea, which decomposes to ammonia under heat treatment) and a stabilizer or thickener (such as polyacrylamide). Alternatively, the cores may be formed, or synthesized, through a solvothermal reduction of ferric salts in nonaqueous solvents, such as ethylene glycol. In each of the embodiments, the superparamagnetic nanocrystals or the core layer, similarly self-assemble into condensed spherical aggregates. Without assembly of superparamagnetic nanocrystals into higher-order structures, the individual nanocrystals may not possess sufficient magnetic moment upon magnetization to overcome thermal energy in suspensions to allow for consistent, repeatable magnetophoretic separation.

In another embodiment of the present disclosure, the superparamagnetic particle cores may be formed by loading superparamagnetic nanocrystals, prepared, for example, by a coprecipitation reaction in aqueous solution or by a thermal decomposition in organic solution, into organic or inorganic colloidal spheres, such as latex or silica spheres, hydrogel microparticles, or dendritic polymers. The loading of these superparamagnetic nanocrystals into carrier structures, such as carriers composed of a ceramic material, a polymeric material or a silicon dioxide, may be performed in situ, such that the nanocrystals and carrier structures would form simultaneously in the same reaction, or in a stepwise manner, such as synthesis of the nanocrystals, followed by encapsulation within the carrier structure or vice-versa. The superparamagnetic nanocrystals may also be synthesized using an emulsion.

After the core layer has been formed, the core layer is then encased with a shell, or insulator shell, layer 102 such as by coating the core layer with an electrical insulator. The shell layer may be formed from amorphous silica or carbon, a polymer, a plastic or ceramic material and its thickness controlled by the concentrations and ratios of reagents during the coating reaction.

The insulator shell assists in prohibiting or reducing the likelihood of the formation of an electrical heterojunction between the photoactive layer 15/generation layer 16/light responsive layer 18 (such as TiO₂) and the material comprising the core layer 12 or superparamagnetic core which may reduce the efficiency or performance of the photocatalyst or photoactive layer 15. The insulator shell is also used to protect the material in the core layer from chemical attack, oxidation, dissolution, and leaching, thus preserving the physical properties of the core layer.

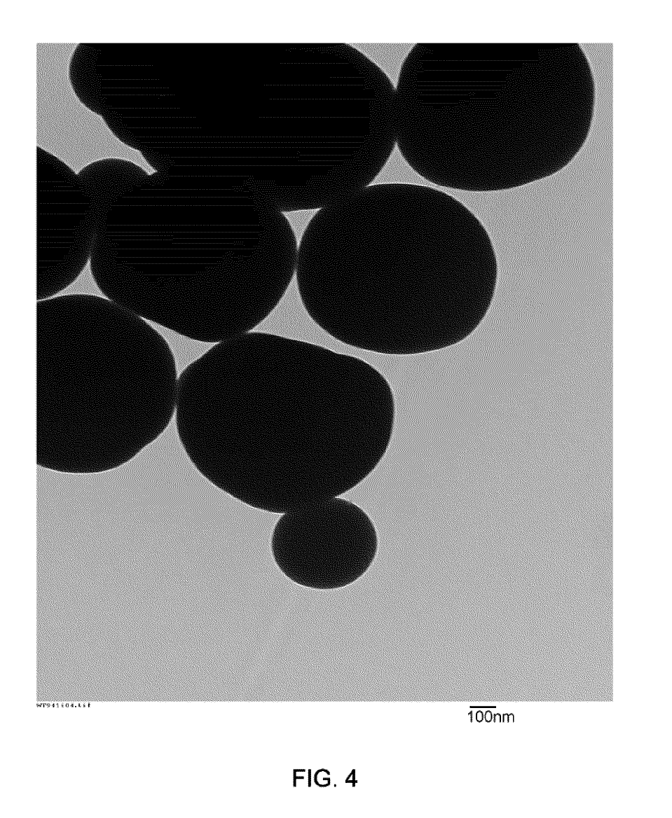

In one embodiment of the present disclosure, a silica layer may be deposited as the shell layer on the surface of the core layer through well-defined sol-gel chemistry. The reaction involves the dispersion of the core layer in, primarily, a non-aqueous solvent such as ethanol, containing a percentage of water and possibly a base or acid as a catalyst. To assist in this process of adding the shell layer, the superparamagnetic core particles of the core layer may be pre-treated with silicic acid, a surfactant or a polymeric surfactant to enhance their dispersion in the non-aqueous solvent and to reduce the likelihood of the silica-coating of aggregates of the core layer. In one embodiment, the polymeric surfactant may be a polyacrylic acid of polymethacrylic acid. To this dispersion, a silicon-containing alkoxide compound is added and allowed to condense on the surface of the superparamagnetic core particles or core layer. This reaction is facilitated when the superparamagnetic core particles are composed primarily of an oxide material with abundant surface hydroxyl groups. A transmission electron micrograph of the superparamagnetic core particles coated with a layer of silica is shown in FIG. 4. As can be seen the surface of the microparticle after the shell layer has been put on is smoother than the surface of the core layer (as shown in FIG. 3).

Next, the charge carrier generation layer is deposited 104 on the surface of the shell layer. In the preferred embodiment TiO₂ is used however, other materials such as, but not limited to, AgPO4, AgCl, Fe2O3, graphene, Bi2O3, Bi2S3, Bi2WO6, C3N4, CdS, CdSe, CeO2, Cu2O, FeS2, PbS, any oxide or ceramic material or semiconductor material or catalyst, may be deposited on the shell layer. In use, when the microparticles are combined to form the water treatment material, the generation layer of each of the microparticles forms a surface interface of the composite microparticles with the water, or aqueous milieu, during photocatalytic water treatment. In some embodiments, pre-formed TiO₂ particles may be attached to the shell layer via titanium alkoxide, titanium chloride or silicon alkoxide to form the generation layer.

In the preferred embodiment when TiO₂ is used, the structure of the TiO₂ deposited is amorphous thereby necessitating subsequent treatments, however each of these subsequent treatments may be seen as depositing TiO₂ on the shell layer. Furthermore, various dopant compounds or elements may be incorporated into the TiO₂ structure during this step to assist the process which may also be seen as depositing TiO₂ on the shell layer. The dopant compounds may include organic compounds, organic elements, or inorganic salts. The organic compounds may be chosen from urea, thiourea, triethylamine while the inorganic elements may be chose from erbium nitrate, rare earth elements, a surfactant or a mixture of surfactants. The surfactants may be selected from a group of polymers, polyols, poloxamers, polysorbates, polyamides, poly(ethylene glycol) or fatty acids.

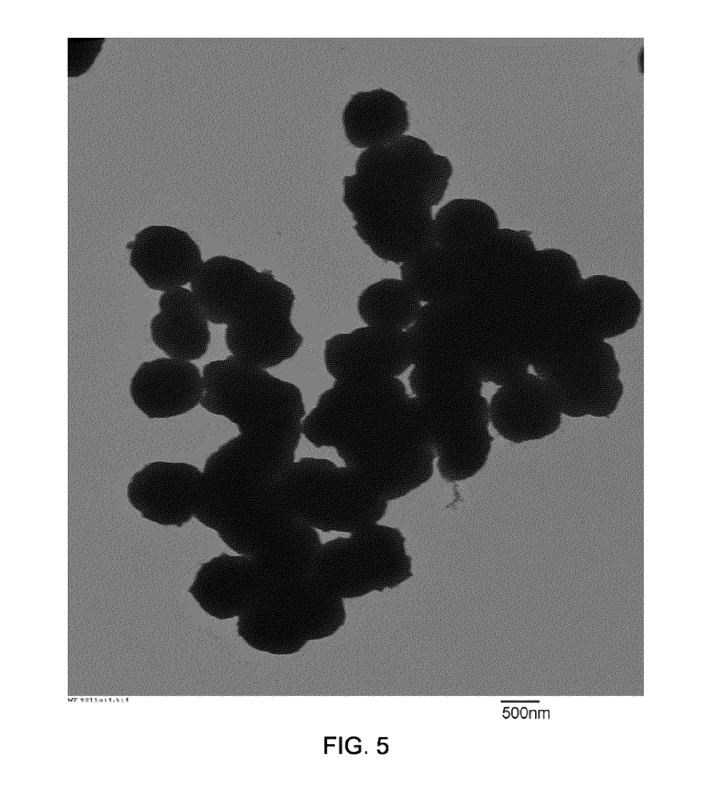

In another embodiment of the present disclosure, the generation layer, preferably TiO₂, may be deposited through a sol-gel reaction, by dispersing the insulator-coated superparamagnetic core layer in ethanol containing a low concentration of water, followed by the addition of a titanium alkoxide, followed by heating at approximately 85° C. for about 90 minutes while stirring. A transmission electron micrograph of the composite particles produced is presented in FIG. 5. In another embodiment, TiO₂ nanosheets may be deposited on the shell layer of the superparamagnetic particles in a solvothermal reaction by dispersing the shell layer and core layer in an alcohol in a pressure vessel, adding a titanium alkoxide precursor and a small quantity of an organic additive such as, but not limited to, diethylenetriamine, followed by heat treatment at approximately 200° C. for about 24 hrs. As in the deposition of the shell layer, the particles may be pre-treated with a surfactant or polymer compound to enhance their dispersion in the non-aqueous solvent and reduce the TiO₂-coating of aggregates of particles. During subsequent calcination or processing these compounds may decompose and act as dopants in the TiO₂, modifying the electronic band structure or surface reactivity of the material, promoting more efficient visible light photocatalysis.

Finally, further processing of the composite microparticles (seen as the combination of the core layer, the shell layer and the photoactive layer) is performed, such as the creation of the light sensitive layer, 106, typically involving a form of heat treatment to crystallize the generation layer into a photocatalytically active phase. In some embodiments, there is no need to create the light sensitive layer as the charge carrier generation layer may provide the necessary properties to allow the microparticle to function as water treatment material with the core layer, the shell layer and the charge carrier generation layer. Prior to the creation of the light sensitive layer, the composite microparticles may be mixed with a solution of at least one surfactant or treated with at least one surfactant. The surfactant may be selected from a group including, but not limited to, polymers, polyols, poloxamers, polysorbates, polyamides, poly(ethylene glycol) or fatty acids.

Other surface treatments such as hydrogenation, doping, or deposition of other metals or materials are also contemplated to enhance the photocatalytic activity of the microparticles with respect to visible light.

In one embodiment, the creation of the light sensitive layer may involve drying the as-synthesized composite microparticles and calcining them at predetermined temperatures, or dispersing the composite microspheres in an aqueous solution inside a pressure vessel, and heating them in a hydrothermal reaction at predetermined temperatures, such as by microwave irradiation. In a preferred embodiment, the calcining takes place in normal air, nitrogen, hydrogen oxygen, sulfur, halogen, a noble gas, or a mixture of these gases. This hydrothermal reaction may be accelerated through the use of microwaves to perform the heating. The particles may also be heat treated by both methods, such as a hydrothermal treatment preceding a calcination treatment.

In an alternative embodiment, the composite microparticles may be dried and powdered after the TiO₂ deposition, followed by calcination at about 500° C. for about 2 hrs. In another embodiment, the calcined composite microparticles may be kept under a hydrogen atmosphere as a further example of a processing step. In this reaction, hydrogen passivates and disorders the surface of the TiO₂, which may enhance the visible light photocatalytic activity of the material through more efficient light absorbtion and stable surface states to enhance the lifetime of separated charge carriers in the semiconductor. Additional chemical reactions or ion implantation may also be employed at this step to incorporate various elements into the structure or onto the surface of the TiO₂. Various metallic compounds, such as, but not limited to, metallic elements, metallic nanocrystals or metallic materials or alloys, may be deposited to enhance charge separation and the photocatalytic efficiency of the TiO₂. The metallic elements may be chosen from iron, nickel, copper, silver, gold, platinum, palladium, or any other metal.

Furthermore, the metallic element or salt or compound may be dissolved in a solution in the presence of the composite microparticles, upon which the solution is illuminated with light to drive a photoelectrochemical reduction reaction of the metal to deposit on the surface of the composite microparticles, wherein the titanium dioxide on the surface of the composite microparticles serves as a photocatalyst during the photoelectrochemical deposition reaction.

Similarly, other materials such as graphene, graphitic carbon, graphite, carbon or any combination of these materials may be deposited to improve the photocatalytic efficiency of the TiO₂. These materials may be deposited through the pyrolysis or thermal decomposition of an organic precursor compound. In one embodiment, the precursor compound may be melamine which has been decomposed in an oxygen-free atmosphere at high temperature.

Alternatively, additional semiconductor nanocrystals or organic dyes may be deposited on the surface of the TiO₂ to sensitize it to visible light by charge carrier injection and separation.

After the further treatment, or heat treatment, the completed microparticles may be treated by hydrogenation by exposing the microparticles to an atmosphere of hydrogen gas or containing hydrogen gas, with or without a catalyst. In one embodiment, the microparticles may either be in the form of a dry powder, dispersed in a liquid, or dispersed as an aerosol when exposed to the hydrogen gas atmosphere or the atmosphere containing hydrogen gas.

The hydrogenation step may involve exposing the microparticles to a hydrogen gas atmosphere, or an atmosphere containing hydrogen gas, at a pressure higher than normal atmospheric pressure, at a temperature in excess of 25° C. or for up to several days continuously. The atmosphere may also be static, dynamically flowing, or bubbling through a liquid dispersion containing the microparticles.

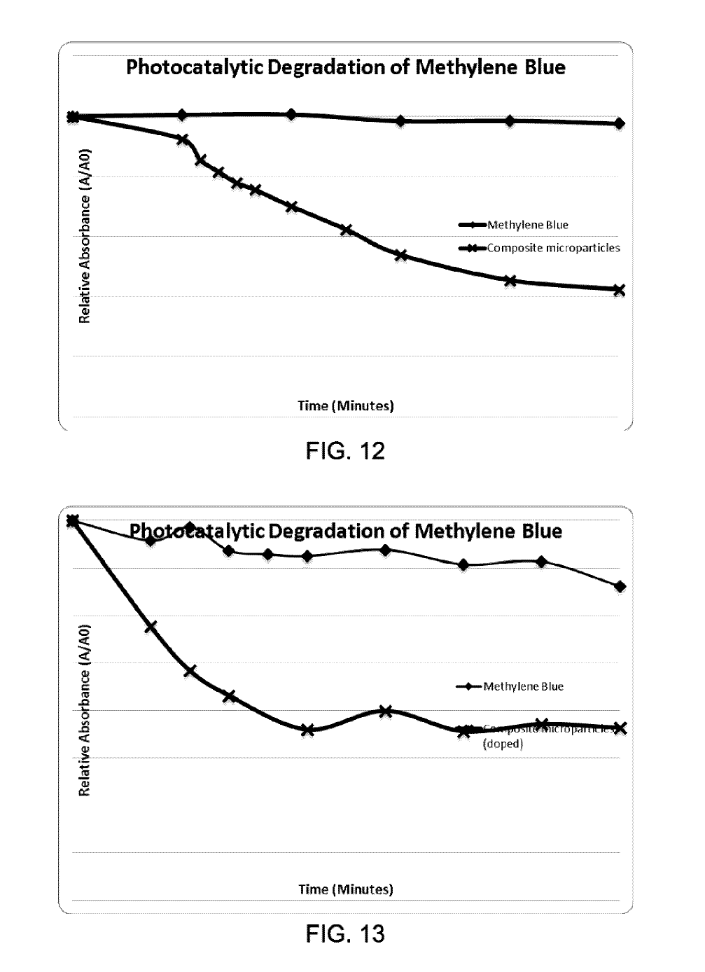

In one specific example, seen as example 1, of the production of a microparticle for combination with other microparticles for use in water treatment, a 50 mM KOH, 0.2 M KNO₃ aqueous solution was purged with nitrogen for 2 hrs. Simultaneously, a 1 M FeSO₄ aqueous solution was prepared and then purged with nitrogen for 30 min. While stirring vigorously, the FeSO₄ solution was mixed with the above KOH and KNO₃ solution such that the final FeSO₄ concentration was 0.325 M, and then the mixture was heated to 90° C., and kept at this temperature for 90 minutes while stirring vigorously. The solution was then washed by magnetic decantation once with 1 M HNO₃, and then four times with equivalent volumes of deionized water. The magnetic precipitate from this reaction was then redispersed in an ethanolic solution containing 8.333 M deionized water and 0.3 M ammonia with the aid of sonication, such that the final concentration of particles was approximately 1 mg/mL. Tetraethyl orthosilicate (TEOS) was then mixed with this solution such that the final TEOS concentration was 55 mM. This mixture was then sonicated continually for 1 hour. After the reaction, the particles were magnetically washed four times with equivalent volumes of ethanol such that the final concentration of particles in ethanol was the same as initially after the reaction. 23.7 mL of this solution was then magnetically concentrated into 12.57 mL of ethanol, and 0.057 mL of deionized water was added. While stirring, 2.37 mL of ethanol containing 0.036 mL of titanium isopropoxide was added dropwise to the particulate dispersion. This mixture was then sealed and heated to 85° C., and allowed to stir at this temperature for 90 minutes. After the reaction, the particles were magnetically washed four times with ethanol, and then dried overnight in air. This dried sample was then calcined in a furnace at 500° C. for 2 hrs in air to obtain the final composite microparticles. The photocatalytic activity of these particles was confirmed by dispersing them in an aqueous solution of methylene blue, irradiating the solution with a UV lamp (Philips PL-S UV/A, 9 W), and monitoring the degradation of the methylene blue over time with a spectrophotometer, as shown in FIG. 12. Aliquots of solution were withdrawn at the timepoints indicated in order to spectrophotometrically determine the concentration of methylene blue. The standard degradation curve of a 1 mg/L methylene blue solution in the absense of catalysts under the same irradiation conditions is also presented as a control.

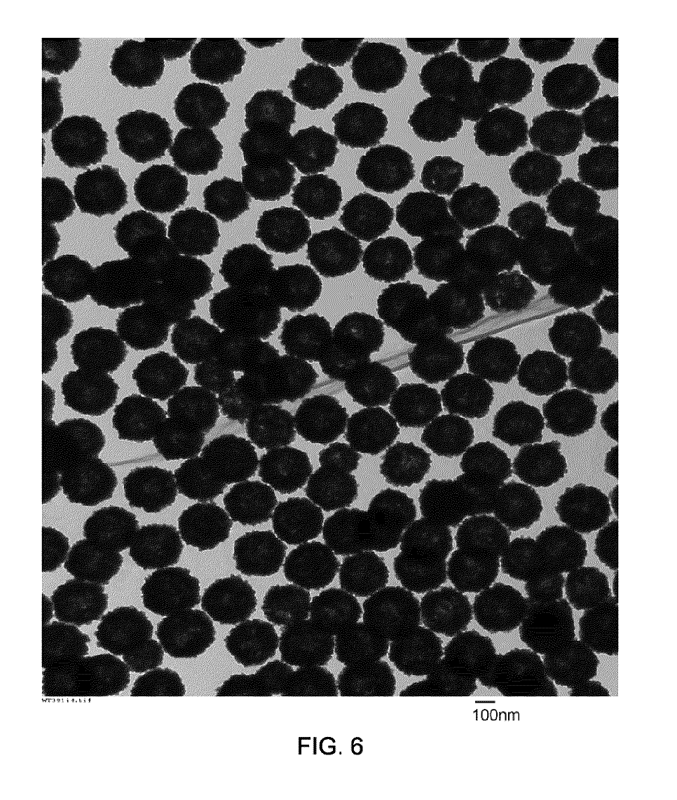

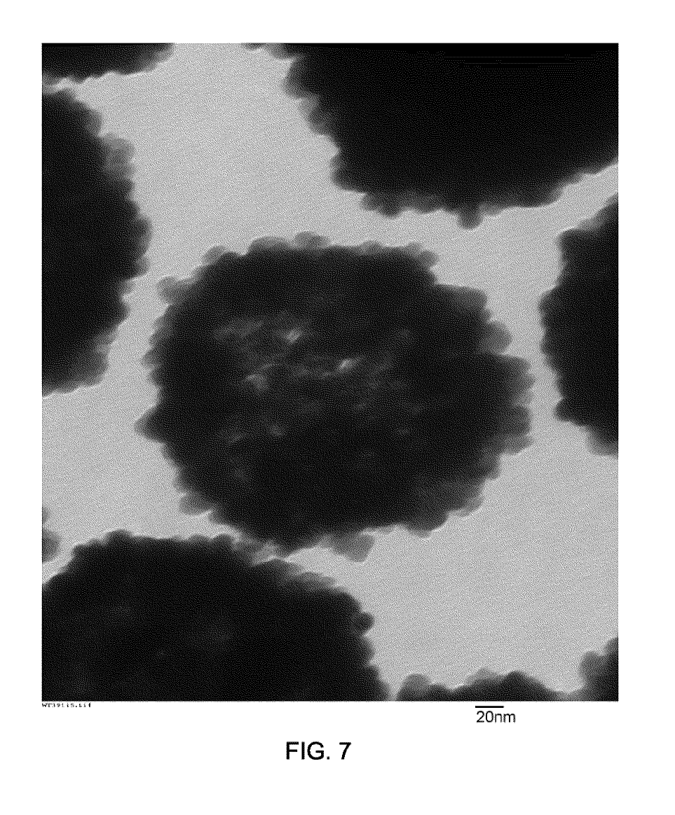

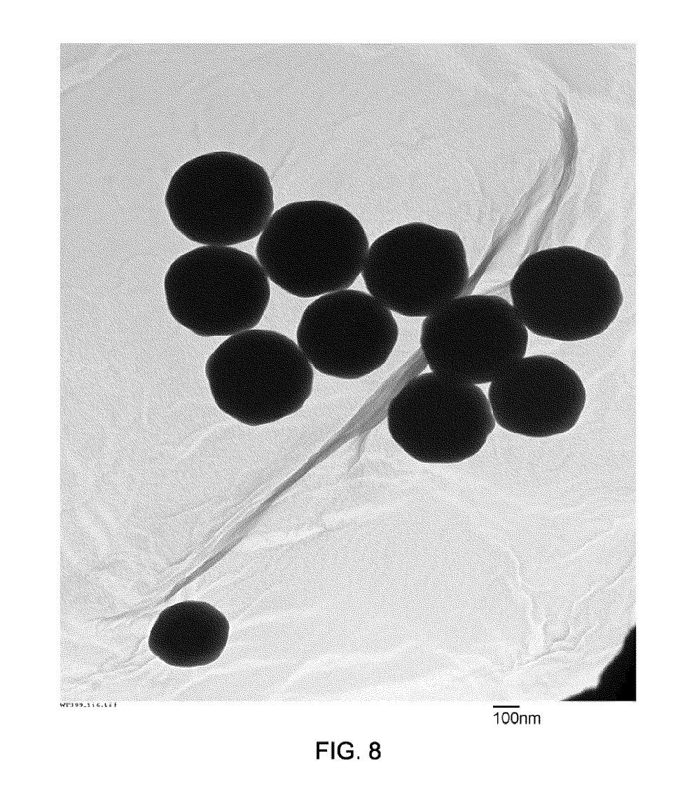

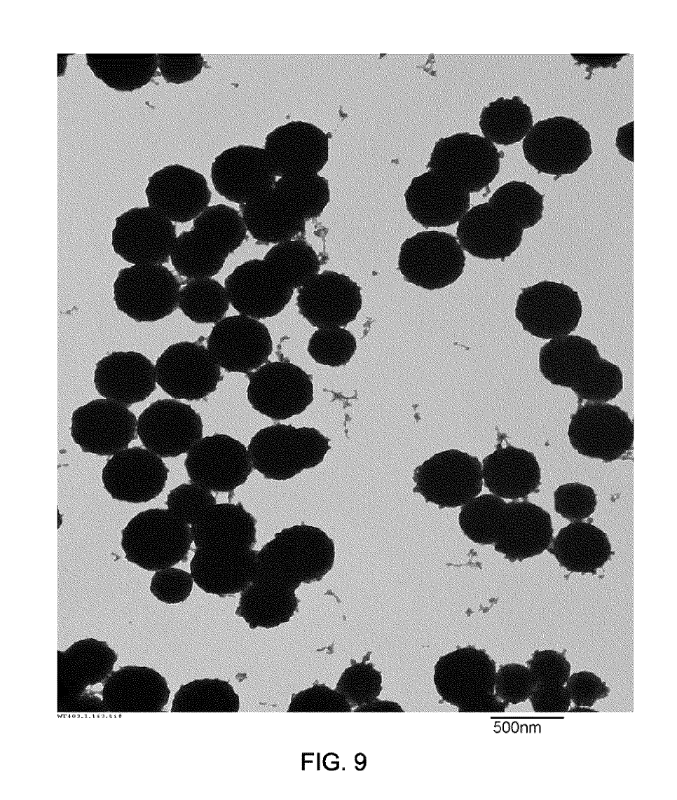

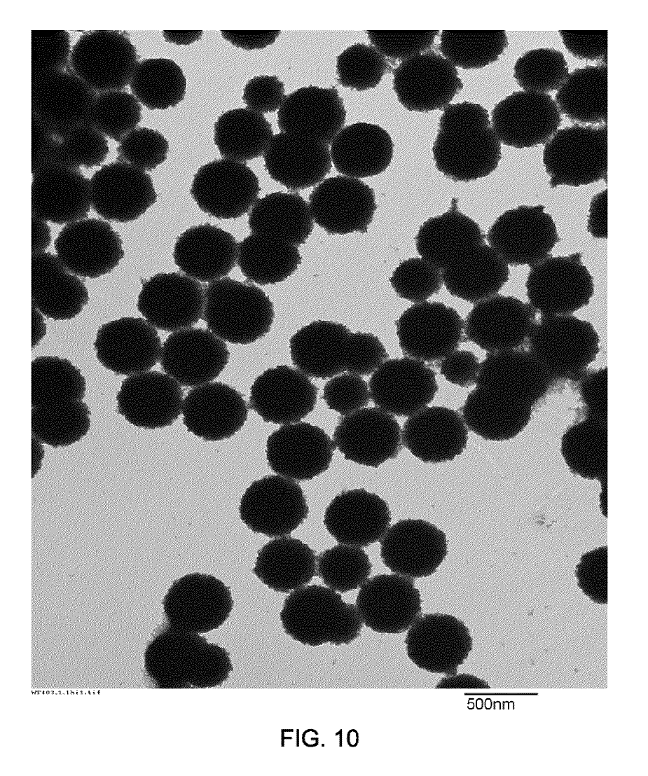

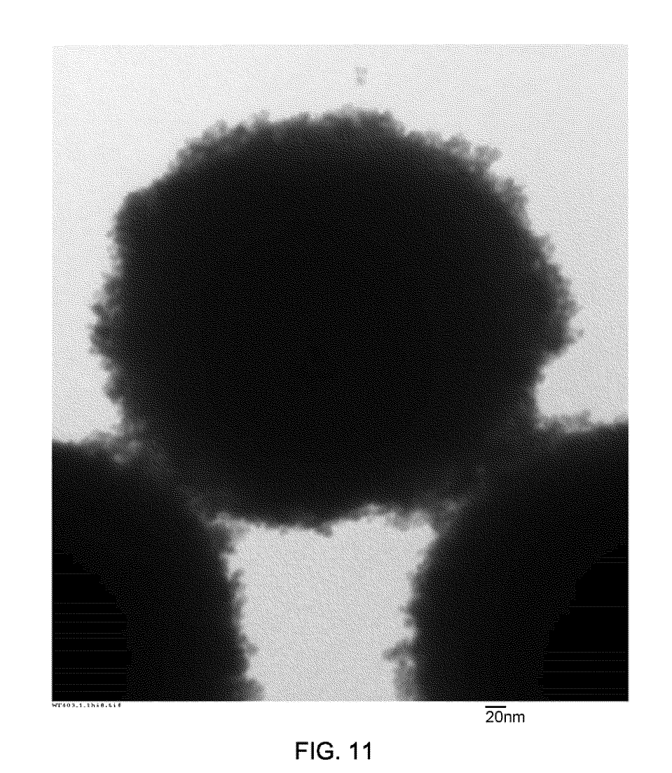

In another example, seen as example 2, of the production of a microparticle for combination with other microparticles for use in water treatment, 0.619 g polyacrylamide (M_{w}=5-6 MDa), 2.426 g sodium citrate dihydrate and 0.743 g urea were dissolved in 78.1 mL of deionized water. Then 4.125 mL of a 1 mol/L solution of FeCl₃ in deionized water was added to the above solution and mixed well. This combined solution was then sealed in a PTFE-lined 125 mL acid digestion pressure vessel and placed in a 200° C. oven for 16 h. After this reaction, the resultant magnetic precipitate (superparamagnetic core particles) were magnetically separated from the solution, and washed well with deionized water and ethanol by magnetic decantation, before being dried at room temperature in air. Transmission electron micrographs or images of these particles are presented in FIGS. 6 and 7. The size of these superparamagnetic core particles may be easily varied by changing the concentration of FeC₃ and sodium citrate dihydrate in the above reaction. 300 mg of the dried powder of the above superparamagnetic core particles was then dispersed in a mixture of 40.5 mL deionized water and 150.3 mL ethanol by sonication. 4.173 mL of ammonium hydroxide (28-30% NH₃ content) was then added to this particle suspension, followed by the slow dropwise addition over the course of an hour of a mixture of 1.116 mL tetraethyl orthosilicate (TEOS) and 3.884 mL ethanol, while stirring the particle suspension vigorously. The reaction was then continuously stirred for a further 18 h at room temperature, after which time the particles were magnetically separated from the solution, and washed well with ethanol by magnetic decantation, before being dried at room temperature in air. A transmission electron micrograph or image of these particles is presented in FIG. 8. 0.6 g of these particles was then dispersed into a mixture of 1.216 mL deionized water in 133.6 mL ethanol by sonication. 0.45 g of hydroxypropyl cellulose (M_{w}=100 kDa) was then added to and dissolved in the above suspension by stirring. A mixture of 6.126 mL titanium(IV) butoxide and 8.874 mL ethanol was then slowly added dropwise to the particle suspension over the course of 3 h, while stirring the particle suspension. This suspension was then refluxed at 85° C. for 90 min, and then cooled to room temperature. The particles were then magnetically separated from solution and washed well with ethanol and deionized water, before being dispersed in 30 mL of deionized water. A transmission electrnoi micrograph or image of these particles is presented in FIG. 9. This 30 mL suspension of the particles in deionized water was then sealed within a 45 mL acid digestion pressure vessel and heated to 180° C. over 90 min, held at 180° C. over 90 min, and then cooled naturally to room temperature (hydrothermal treatment). The particles were then magnetically separated and washed well with deionized water by magnetic decantation, before being dried at room temperature in air. Transmission electron micrograph or images of these particles are presented in FIGS. 10 and 11. This dried powder was then calcined in a furnace at 500° C. for 3 hrs in air to obtain the final composite microparticles.

In another example, seen as example 3, of the production of a microparticle for combination with other microparticles for use in water treatment, which may be seen as a Doped Visible Light Active Microparticles, the microparticle was prepared as in example 1, but in which thiourea was included in the isopropanol solution at a concentration of 0.5 M during the titanium dioxide deposition reaction. The photocatalytic activity of these particles was confirmed by dispersing them in an aqueous solution of methylene blue, irradiating the solution with a fluorescent lamp emitting light in the visible range, and monitoring the degradation of the methylene blue over time with a spectrophotometer, as shown in FIG. 13 which provides the results. Aliquots of solution were withdrawn at the timepoints indicated in order to spectrophotometrically determine the concentration of methylene blue. The standard degradation curve of a 1 mg/L methylene blue solution in the absense of catalysts under the same irradiation conditions is also presented as a control.

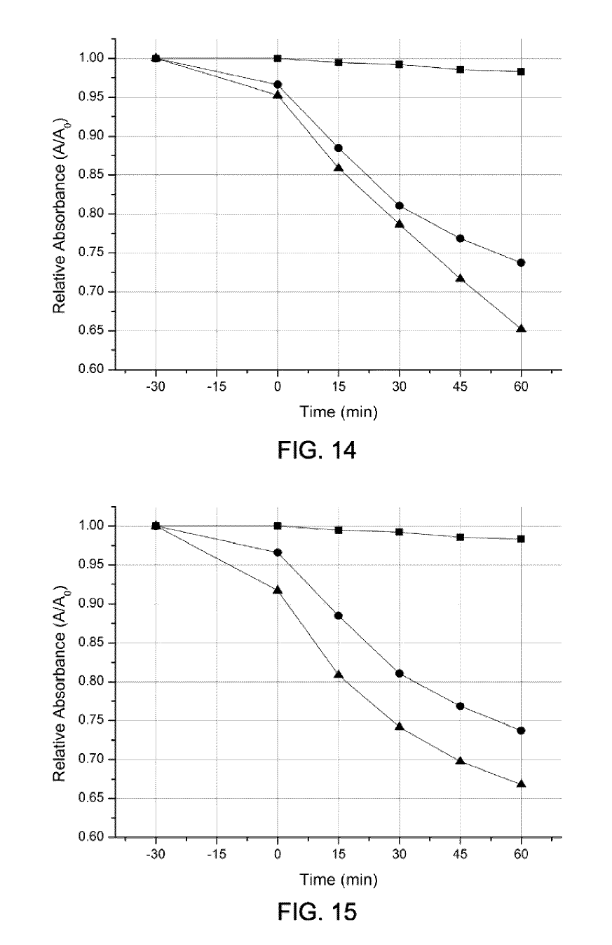

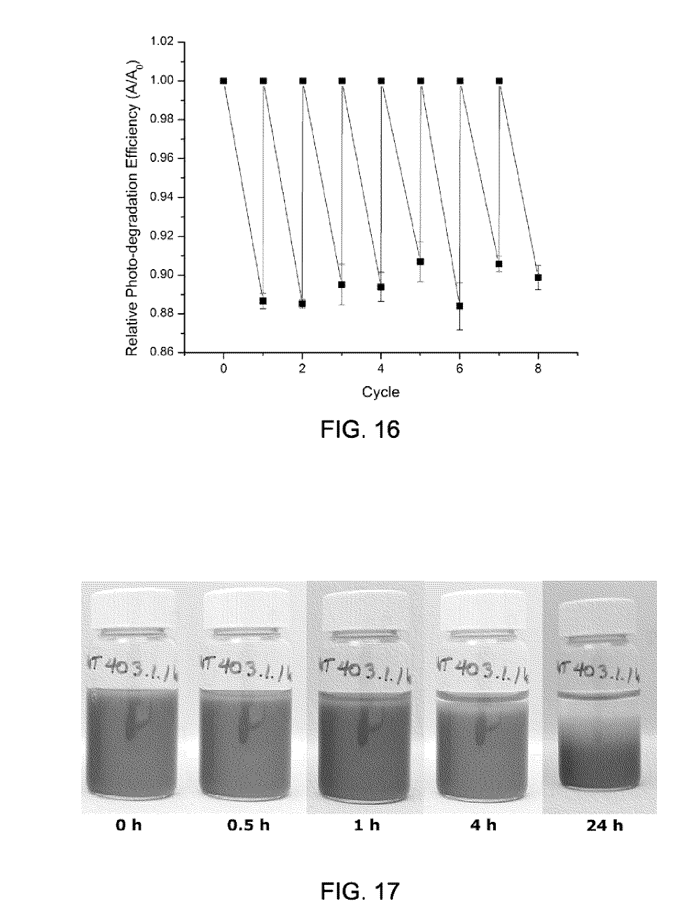

In another example, seen as example 4, of the production of a microparticle for combination with other microparticles for use in water treatment, which may also be known as Pd Modification of Composite Microparticles, a solution of PdCl₂ was prepared by mixing 12.5 mg PdCl₂ with 0.141 mL 1 mol/L hydrochloric acid (aqueous) and 14.859 mL deionized water. 10 mL of this solution was then mixed with 90 mL deionized water. The pH of this solution was then adjusted to 9.4 using 1 mol/L NaOH (aqueous). 100 mg of the composite microparticles, prepared according to example 2, were then dispersed into this solution by sonication. The solution was then added to a sealed flask and purged with pure argon gas for 1 h. 7 mL ethanol was then injected into the sealed flask, and then the flask was illuminated with an ultraviolet lamp for 24 h while stirring. After the reaction, the particles were magnetically separated, washed well with deionized water by magnetic decantation, and then dried at room temperature in air. The enhanced photocatalytic activity of these particles was confirmed by dispersing them in an aqueous solution of methylene blue, irradiating the solution with a UV light source (UVP CL-1000, maximum output at 254 nm), and monitoring the degradation of the methylene blue over time with a spectrophotometer, as shown in FIG. 14. In testing, the composite microparticles were added to 30 mL of a 5.5 mg/L methylene blue solution at a particle concentration of 0.05 mg/mL, and then this solution was stored in the dark for 30 min prior to the test to achieve adsorption-desorption equilibrium of the dye with the particles. The solution was then irradiated with ultraviolet light in a controlled enclosure for the remaining duration of the experiment, starting from the time point of 0 min. Aliquots of solution were withdrawn at the timepoints indicated above in order to spectrophotometrically determine the concentration of methylene blue.

In another example, seen as example 5, of the production of a microparticle for combination with other microparticles for use in water treatment, which may also be known as Ag Modification of Composite Microparticles, 0.787 mL of a 1 mg/mL AgNO₃ (aqueous) was mixed with 92 mL deionized water. The pH of this solution was then adjusted to 9.5 using 1 mol/L NaOH (aqueous). 100 mg of the composite microparticles, prepared according to Example 2, were then dispersed into this solution by sonication. The solution was then added to a sealed flask and purged with pure argon gas for 1 h. 7 mL ethanol was then injected into the sealed flask, and then the flask was illuminated with an ultraviolet lamp for 24 h while stirring. After the reaction, the particles were magnetically separated, washed well with deionized water by magnetic decantation, and then dried at room temperature in air. The enhanced photocatalytic activity of these particles was confirmed by dispersing them in an aqueous solution of methylene blue, irradiating the solution with a UV light source preferably having a maximum output at 254 nm), and monitoring the degradation of the methylene blue over time with a spectrophotometer, as shown in FIG. 15. As with the results from FIG. 14, the composite microparticles were added to 30 mL of a 5.5 mg/L methylene blue solution at a particle concentration of 0.05 mg/mL, and then this solution was stored in the dark for 30 min prior to the test to achieve adsorption-desorption equilibrium of the dye with the particles. The solution was then irradiated with ultraviolet light in a controlled enclosure for the remaining duration of the experiment, starting from the time point of 0 min. Aliquots of solution were withdrawn at the timepoints indicated above in order to spectrophotometrically determine the concentration of methylene blue.

FIG. 17 is an example of the stability of the colloidal suspension or slurry of the composite microparticles against gravitational settling. The composite microparticles, prepared according to example 2, were dispersed in deionized water by sonication at a concentration of 1 mg/mL, shaken, and then let to stand (time point 0 h). Photos were then taken of the suspension at the time points indicated without disturbing the vial by shaking or stirring in any way. The particle dispersion is observed to be relatively stable against gravitational settling for up to 24 h.

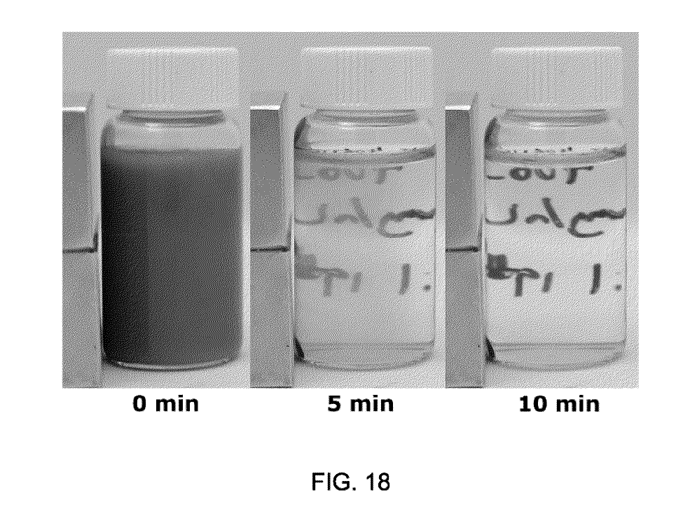

FIG. 18 is an example of magnetic separation of composite microparticles from a colloidal suspension or slurry. The composite microparticles, prepared according to example 2, were dispersed in deionized water by sonication at a concentration of 1 mg/mL, shaken, and then let to stand to the right of a neodymium magnet (time point 0 min). Photos were then taken of the suspension at the time points indicated without disturbing the vial by shaking or stirring in any way. The particles are observed to be completely separated from suspension to the surface of the vial closest to the magnet within 10 min.

In operation, the group of microparticles may be used for water treatment in the removal or degradation or water contaminants. Due to the structure or make-up of the microparticles, the microparticles may be activated via a sunlight, moonlight, electrical illumination, ultraviolet lighting, infrared light, or visible light. As the microparticles contact the water and contaminants, the contaminants or pathogens typically are adsorbed to the surface of the microparticles. Some target contaminants for the microparticles include, but are not limited to, heavy metal ions, organic chemicals or microorganisms, or more specifically, polyaromatic hydrocarbons, persistent organic pollutants, endocrine inhibitors or disruptors, dyes, pesticides, herbicides, pharmaceuticals, hormones, toxins, proteins, solvents, polymers, plastics, bisphenol A, butylated hydroxyanisole, alkylphenols, phenols, alkylphenols, phthalates, polychlorinated biphenyls, antibiotics, personal care products, fragrances, preservatives, disinfectants, disinfection byproducts, antiseptics, heavy metals, or any type of microorganism or virus. The use of the microparticles may be enhanced with other chemical additives to improve the efficacy or the water treatment, however, it will be understood that the microparticles may be solely used and still provide an efficient water treatment solution. To disperse the microparticles within the water to be treated, the microparticles may be dispersed via sonication, ultrasonication or mechanical agitation. If the water is in a handheld container, the water may be mixed with the microparticles via stirring, shaking or mixing. After the water treatment, in order to remove the microparticles so that they do not become contaminants, the microparticles may be removed by a magnetic field, a filter, or gravity or any other types of mechanical separation.

Turning to FIG. 19, a schematic view of a water treatment system is shown. It will be understood that only the portion of the water treatment system involving the microparticles is shown and that the other apparatus for operation, such as, but not limited to, the apparatus required to retrieve or receive the contaminated water, the apparatus for delivery of the purified water and, the apparatus for flowing the water through the system are not disclosed.

In this portion of the water treatment process, the tubing or piping 30 receives the flow of contaminated water (shown as arrow 32). While the water is flowing within the tubing 30, the microparticles 10 are introduced to the water such as via a separate valve 34 integrated with the tubing 30. The tubing 30 may be transparent to receive any types of light, including visible or solar, so as to activate the microparticles to begin treating the water. As the cleaned water continues to flow down the tubing 30, the microparticles 10 are caught within a filter, or magnet 36 at the end of the tubing in order to allow the treated water to continue within the processing plant. If the microparticles are not captured, the water may be deemed contaminated by the microparticles.

Turning to FIGS. 20a and 20b, a second embodiment of a water treatment system is shown. In this embodiment, the tubing 40 includes a set of lighting tubes 42 which have a layer of water treatment material on its surface. In other words, the microparticles may be combined to form a substance which may be applied to the surface of the lighting tubes. In operation, as the water flows (as indicated by arrow 44) down the tubing 40, the lighting tubes are turned on in order to activate the water treatment material so that the microparticles can begin to treat the water.

In another embodiment, microparticles may be produced which are larger than the size of the microparticles defined above. In use, these particles may be dropped into a larger container to treat water and allowed to settle (via gravity) to the bottom of the container where it can then be removed via various methods. The use of microparticles in the embodiment of FIG. 19 allows the microparticles to remain suspended within the contaminated water to provide improved efficiency for treating water.

In an alternative embodiment, the microparticles may be used in the dressing of a wound, may be internalized in the body as a medical treatment or possibly used as a disinfectant. A further use of the microparticles may be in personal care products or cosmetics such as sunscreen or the treatment of cancer or a disease.

The above-described embodiments of the disclosure are intended to be examples only. Alterations, modifications and variations can be effected to the particular embodiments by those of skill in the art without departing from the scope of the disclosure, which is defined solely by the claims appended hereto.

1. A microparticle for use in water treatment comprising:
a core layer;
a shell layer, deposited on and encasing the core layer; and
a photoactive layer surrounding the shell layer.

2. The microparticle of claim 1 wherein the photoactive layer comprises a charge carrier generation layer.

3. The microparticle of claim 2 wherein the photoactive layer further comprises a light sensitive layer.

4. The microparticle of claim 3 wherein the light sensitive layer is created by modifying the charge carrier generation layer.

5. The microparticle of claim 1 wherein the core layer comprises superparamagnetic particle cores.

6. The microparticle of claim 5 wherein the superparamagnetic particle cores are formed through a hydrothermal reduction and precipitation of ferric salts in aqueous solution, in the presence of a carboxylate source, a precipitant and a stabilizer or thickener.

7. The microparticle of claim 1 wherein material for the shell layer is selected from a group consisting of amorphous silica, amorphous carbon, a polymer, a plastic and a ceramic material.

8. The microparticle of claim 1 wherein the shell layer is deposited on the core layer via a sol-gel chemistry.

9. The microparticle of claim 1 wherein the photoactive layer is deposited on the shell layer.

10. The microparticle of claim 7 wherein the photoactive layer is titanium dioxide.

11. The microparticle of claim 10 wherein the photoactive layer further comprises dopants.

12. The microparticle of claim 1 wherein the core layer is made from magnetite.

13. The microparticle of claim 1 wherein the shell layer is made from silica.

14. A method of producing a superparamagnetic photocatalytic microparticle comprising:
producing a core layer;
encasing the core layer with a shell layer; and
depositing a charge carrier generation on the shell layer.

15. The method of claim 14 further comprising:
creating a solar or visible light sensitive layer from the charge carrier generation layer.

16. The method of claim 14 where synthesizing comprises:
forming superparamagnetic particle cores via a hydrothermal reduction.

17. The method of claim 14 wherein encasing the core layer comprises coating the core layer with an electrical insulator.

18. The method of claim 14 wherein encasing the core layer comprises depositing the shell layer on the core layer via sol-gel chemistry.

19. The method of claim 14 wherein depositing the charge carrier generation layer comprises a sol-gel reaction.

20. The method of claim 14 wherein depositing the charge carrier generation layer comprises a solvothermal or hydrothermal reaction.

21. The method of claim 13 wherein creating the light sensitive layer comprises heat treating the charge carrier generation layer into a photocatalytically active phase.

22. The method of claim 12 wherein depositing the charge carrier generation layer further comprises adding dopant compounds to the charge carrier layer.

23. The method of claim 22 wherein adding dopant compounds comprises adding organic compounds or inorganic salts to the charge carrier generation layer.

24. The method of claim 12 further comprising active layer modification the charge carrier generation layer.

25. The method of claim 24 wherein active layer modification comprises introducing dopants, nanocrystals, rare earth metals or organics to a surface of the core layer, shell layer or charge carrier generation layer.

26. The method of claim 24 wherein active layer modification comprises: thiourea doping, graphene sensitization or PD/Ag deposition.

27. A method of water treatment comprising:
adding a set of microparticles to contaminated water, each of the set of microparticles including a core layer, a shell layer and a charge carrier generation layer;
exposing the contaminated water and set of particles to light to treat the contaminated water; and
removing the set of microparticles from the treated water.

28. A method of water treatment comprising:
creating a slurry, the slurry including a set of microparticles, each of the set of microparticles including a core layer, a shell layer and a charge carrier generation layer;
adding the slurry to contaminated water;
exposing the contaminated water and the slurry to light to treat the contaminated water; and
removing the slurry from the treated water.
